(19) United States
(12) Patent Application Publication
(10) Pub. No.: US 2025/0284882 A1
(43) Pub. Date: Sep. 11, 2025

(54) INFORMATION PROCESSING DEVICE, INFORMATION PROCESSING METHOD, AND RECORDING MEDIUM

(71) Applicant: NEC Corporation, Tokyo (JP)

(72) Inventors: Satoshi ASHIHARA, Tokyo (JP); Masato KAWASAKI, Tokyo (JP)

(73) Assignee: NEC Corporation, Tokyo (JP)

(21) Appl. No.: 19/001,746

(22) Filed: Dec. 26, 2024

(30) Foreign Application Priority Data
Mar. 5, 2024 (JP) 2024-032990
Jul. 10, 2024 (JP) 2014-110680

(51) Int. Cl. G06F 40/186; G06F 16/93

(52) U.S. Cl. CPC G06F 40/186; G06F 16/93

(57) ABSTRACT

In an information processing device, an acquisition means acquires a log indicating a record in which a document, which is output by a model for generating the document containing a content indicated in an instructive sentence, has been browsed. A specifying means specifies characteristics of the content having a predetermined level of attention based on the log. A creation means creates the instructive sentence so as to generate the document in accordance with the characteristics specified.

### TECHNICAL FIELD

This disclosure relates to a technology for a feedback analysis of contents.

### BACKGROUND ART

Conventionally, a technology has been known to acquire browsing logs of users and provide contents which match preferences of the user. For instance, Patent Document 1 describes a technology for changing content placement, alignment, etc. based on a statistical amount obtained by a statistical process which has been conducted to the browsing logs and a browsing correlation.
Patent Document 1: Japanese Laid-open Patent Publication No. 2004-362539

### SUMMARY

However, even with a method in Patent Document 1, it is not always possible to properly reflect an analysis result of browsing logs to a content generation.

One object of the present disclosure is to provide an information processing device capable of generating an appropriate content based on the analysis result of one or more browsing logs.

According to an example aspect of the present invention, there is provided an information processing device including:
at least one memory configured to store instructions; and
at least one processor configured to execute the instructions to:
acquire a log indicating a record in which a document, which is output by a model for generating the document containing a content indicated in an instructive sentence, has been browsed;
specify characteristics of the content having a predetermined level of attention based on the log; and
create the instructive sentence so as to generate the document in accordance with the characteristics specified.

According to another example aspect of the present invention, there is provided an information processing method performed by a computer, the information processing method including:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.

According to still another example aspect of the present invention, there is provided a non-transitory computer-readable recording medium storing a program causing a computer to execute processing of:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.

According to a further example aspect of the present invention, there is provided an information processing device including:
a relationship specifying means configured to specify a relationship between a level of attention to a document and features representing characteristics of a content;
a feature specifying means configured to specify features having a predetermined level of attention based on the relationship; and
a content creation means configured to create a content having the characteristics represented by the features specified.

### Effect

According to the present disclosure, it is possible to provide an information processing device capable of generating an appropriate content based on an analysis result of browsing logs.

### BRIEF DESCRIPTION OF THE DRAWINGS

FIG. 1 is a diagram illustrating an overall configuration of a content analysis system according to the present disclosure.

FIG. 2 is a block diagram illustrating a hardware configuration of an information processing device according to the present disclosure.

FIG. 3 is a block diagram illustrating a functional configuration of the information processing device according to the present disclosure.

FIG. 4 illustrates an example of a label.

FIG. 5A and FIG. 5B illustrate examples of a label assignment method.

FIG. 6 illustrates an example of an analysis of a title.

FIG. 7 illustrates an example in which analysis results of titles are represented by a scatter plot.

FIG. 8 illustrates an example of an analysis of a body text.

FIG. 9 illustrates an example in which analysis results of body texts are represented by the scatter plot.

FIG. 10 is a flowchart of a generation process of an article.

FIG. 11 is a flowchart of an analysis process of browsing logs.

FIG. 12 is a block diagram illustrating a functional configuration of another information processing device according to the present disclosure.

FIG. 13 illustrates another example of the analysis of the body text.

FIG. 14 illustrates an example in which the analysis results of the body texts are represented by the scatter plot.

FIG. 15 is a block diagram illustrating a functional configuration of another information processing device according to the present disclosure.

FIG. 16 is a flowchart of a process by another information processing device according to the present disclosure.

### EXAMPLE EMBODIMENTS

Preferred example embodiments of the present disclosure will be described with reference to the accompanying drawings.

### First Example Embodiment

### [Overall Configuration]

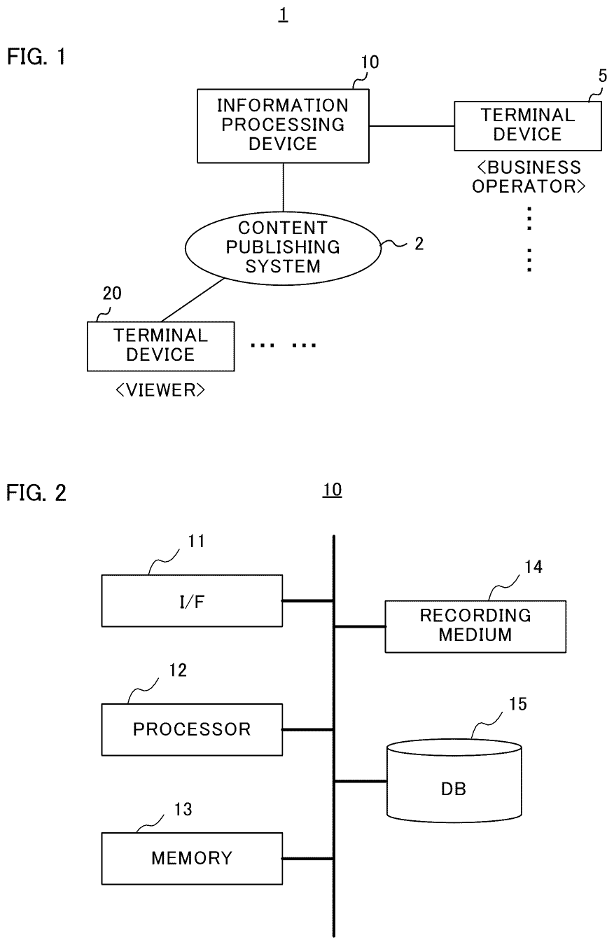

FIG. 1 shows an overall configuration of a content analysis system to which an information processing device according to the present disclosure is applied. The content analysis system 1 includes a content publishing system 2, an information processing device 10, each terminal device 5 of a business operator, and each terminal device 20 of a viewer. Incidentally, a plurality of the terminal devices 5 and a plurality of the terminal devices 20 may be included in the content analysis system 1.

The content publishing system 2 is a system in which content prepared by each business operator for a website is published for a large number of viewers. The content publishing system 2 of the present example embodiment provides each website accessible from each terminal device 20. The website provided by the content publishing system 2 will be simply referred to as a “website” hereafter. The content publishing system 2 is formed by, for instance, a server device.

The content in the present example embodiment corresponds to, for instance, a sentence such as a brand story or a column article of a business, a news article, etc., and hereinafter, is simply referred to as an “article”.

The information processing device 10 generates an article of a business operator based on a request of the terminal device 5 and transmits the article to the content publishing system 2. Furthermore, the information processing device 10 acquires browsing logs of the article from the content publishing system 2 and analyzes a tendency of the article of interest by the viewer. The information processing device 10 communicates with the content publishing system 2 and the terminal device 5 through a network such as the Internet.

The terminal device 5 is operated by a person in charge (hereinafter, also referred to as a “user”) of the business operator (a company, etc.) and is used to generate the article to be published to the website. The terminal device 5 is formed, for instance, by a personal computer or a tablet terminal, and communicates with the information processing device 10 through the network such as the Internet.

The terminal device 20 is operated by a viewer and is used to browse the article of the business operator published to the website. The terminal device 20 is formed, for instance, by a personal computer or a tablet terminal, and communicates with the content publishing system 2 through the network such as the Internet.

### [Hardware Configuration]

FIG. 2 is a block diagram illustrating a hardware configuration of the information processing device 10 according to a first example embodiment. As shown, the information processing device 10 includes an interface (I/F) 11, a processor 12, a memory 13, a recording medium 14, and a database (DB) 15.

The I/F 11 communicates with the content publishing system 2 and the terminal device 5 through the network such as the Internet.

The processor 12 is a computer such as a CPU (Central Processing Unit) and controls the entire information processing device 10 by executing programs prepared in advance. The processor 12 may be a GPU (Graphics Processing Unit), a DSP (Digital Signal Processor), an MPU (Micro Processing Unit), an FPU (Floating Point number Processing Unit), a PPU (Physics Processing Unit), a TPU (Tensor Processing Unit), a quantum processor, a microcontroller, or a combination thereof. The processor 12 performs a generation process of the article and the analysis process of the browsing logs, which will be described later.

The memory 13 is formed by a ROM (Read Only Memory), a RAM (Random Access Memory), etc. The memory 13 is also used as a working memory during executions of various processes by the processor 12.

The recording medium 14 is a non-volatile and non-transitory recording medium such as a disc-shaped recording medium or a semiconductor memory and is formed to be detachable from the information processing device 10. The recording medium 14 records various programs executed by the processor 12. In a case where the information processing device 10 executes various kinds of processes, the programs recorded on the recording medium 14 are loaded into the memory 13 and executed by the processor 12.

The DB 15 stores data used to generate each article, for instance, questionnaires and syntax tables to be discussed later. Also, the DB 15 stores the browsing logs described later.

In addition to the above, the information processing device 10 may include a display device such as a liquid crystal display or a projector, and an input device such as a keyboard or a mouse. The display device and input device, for instance, are used by a manager of the information processing device 10 to perform the necessary management.

### [Functional Configuration]

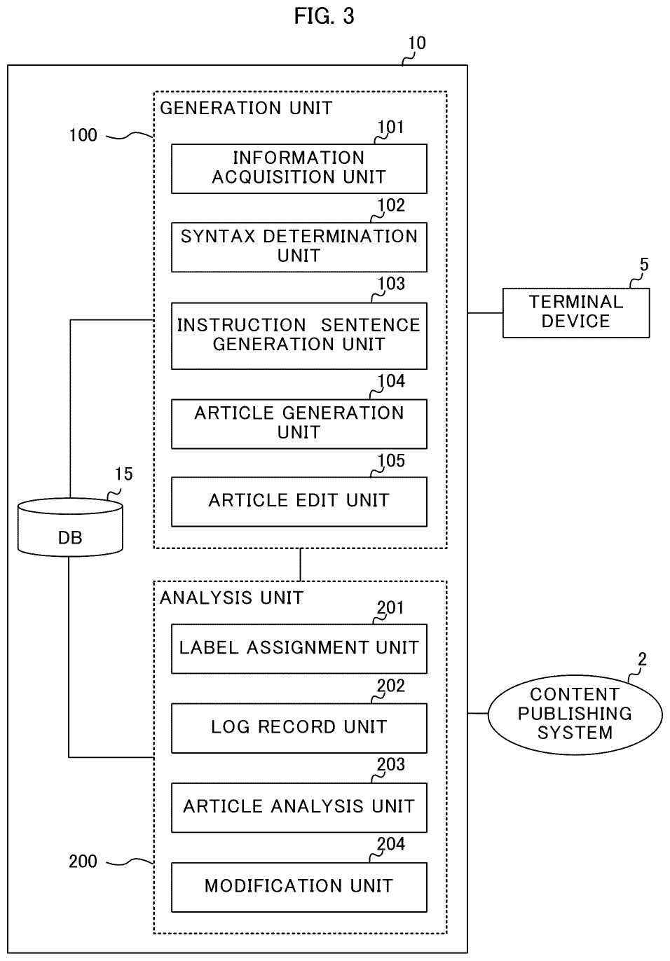

FIG. 3 is a block diagram showing a functional configuration of the information processing device 10 according to the first example embodiment. The information processing device 10 functionally includes a generation unit 100 and an analysis unit 200, in addition to the DB 15 described above.

### (Generation Unit)

First, the generation unit 100 will be described. The generation unit 100 generates the article of the business operator and transmits the article to the content publishing system 2. The generation unit 100 includes an information acquisition unit 101, a syntax determination unit 102, an instructive sentence generation unit 103, an article generation unit 104, and an article edit unit 105.

The generation unit 100 transmits an input screen for a profile of the business operator and a questionnaire, to the terminal device 5 through the I/F 11. The user operates the terminal device 5, inputs the profile of the business operator (hereinafter, also referred to as a “business profile”) and an answer of the questionnaire (hereinafter, also referred to as a “questionnaire answer”), and transmits the questionnaire answer to the information processing device 10.

The generation unit 100 receives the business profile and the questionnaire answer from the terminal device 5. The business profile and the questionnaire answer are input into the information acquisition unit 101. The information acquisition unit 101 outputs the business profile and the questionnaire answer to the syntax determination unit 102 and the instructive sentence generation unit 103.

The syntax determination unit 102 selects a syntax used to generate the instructive sentence from among a plurality of syntaxes stored in the DB 15. The syntax corresponds to a template for the instructive sentence used to instruct the generation of the article. For instance, the DB 15 stores a syntax table in which the answer is corresponded to a certain item in the questionnaire to the syntax. The syntax determination unit 102 refers to the syntax table and selects the syntax corresponding to the answer of the certain item among the questionnaire answers input from the information acquisition unit 101 as the syntax for generating the instructive sentence. The syntax determination unit 102 outputs the selected syntax to the instructive sentence generation unit 103.

The instructive sentence generation unit 103 generates an instructive sentence by inputting the business profile and the questionnaire answer to a corresponding input portion of the syntax. The instructive sentence generation unit 103 outputs the instructive sentence generated, to the article generation unit 104.

The article generation unit 104 generates an article including a title and a body text based on the instructive sentence. Specifically, the article generation unit 104 receives the instructive sentence in a generative AI and acquires the article as a reply to the instructive sentence from the generative AI. The article generation unit 104 uses, for instance, a large language model (LLM) as the generative AI. The LLM is a natural language processing model trained on a large amount of text data to learn relationships between words within sentences. The LLM generates a related string associated with a target string from the target string which has been input. For instance, ChatGPT by OpenAI, etc. is considered as the LLM. The article generation unit 104 outputs the generated article to the article edit unit 105.

The article edit unit 105 generates an edit screen for editing the article, and transmits the edit screen to the terminal device 5. Then, the article edit unit 105 receives an edit operation with respect to the article from the terminal device 5. For instance, the user may perform various edit operations such as modifying text, inserting an image, changing a font, etc. for the article displayed on the display of the terminal device 5. The article edit unit 105 performs an article edit process according to the edit operations of the user.

Moreover, the article edit unit 105 receives a publication operation of posting the article from the terminal device 5. The publication operation is an operation to indicate an intention to publish the article to others. In a case where the user determines that the article is to be published to the website, the user conducts the publication operation on the article. In a case where the publication operation is received from the terminal device 5, the article edit unit 105 transmits a relevant article to the content publishing system 2, and outputs the relevant article to the analysis unit 200.

The content publishing system 2 publishes each article to the website. The viewer operates the terminal device 20 to access the website provided by the content publishing system 2, and browses the article of the business operator. Incidentally, each website provided by the content publishing system 2 has several levels of hierarchy, for instance, from a home page to other web pages. On a top page, titles of articles of the business operator are displayed in a list, etc. The viewer selects one title of the articles to be browsed from the top page, and is navigated to a page of a relevant article.

Also, the content publishing system 2 records each access history from the terminal device 20. The access history includes, for instance, information that uniquely identifies the viewer, an access date and time, an accessed page, and a dwell time spent on the accessed page.

### (Analysis Unit)

Next, the analysis unit 200 will be described. The analysis unit 200 analyzes a browsing trend of the viewer based on the browsing logs of the article published on the website. Specifically, the analysis unit 200 analyzes the browsing trend of the viewer with respect to three elements: “title”, “body text”, and “Web design” of the article. For instance, the analysis unit 200 analyzes a correlation between characteristics and a browsing behavior for the elements of “title” and “body text” of the article. Also, the analysis unit 200 analyzes the Web design effectively by performing an AB test for the element of “Web design” of the article and comparing elements of Web pages for each article. In the following, the analysis of “title” and “body text” of the article will be described.

The analysis unit 200 includes a label assignment unit 201, a log record unit 202, an article analysis unit 203, and a modification unit 204.

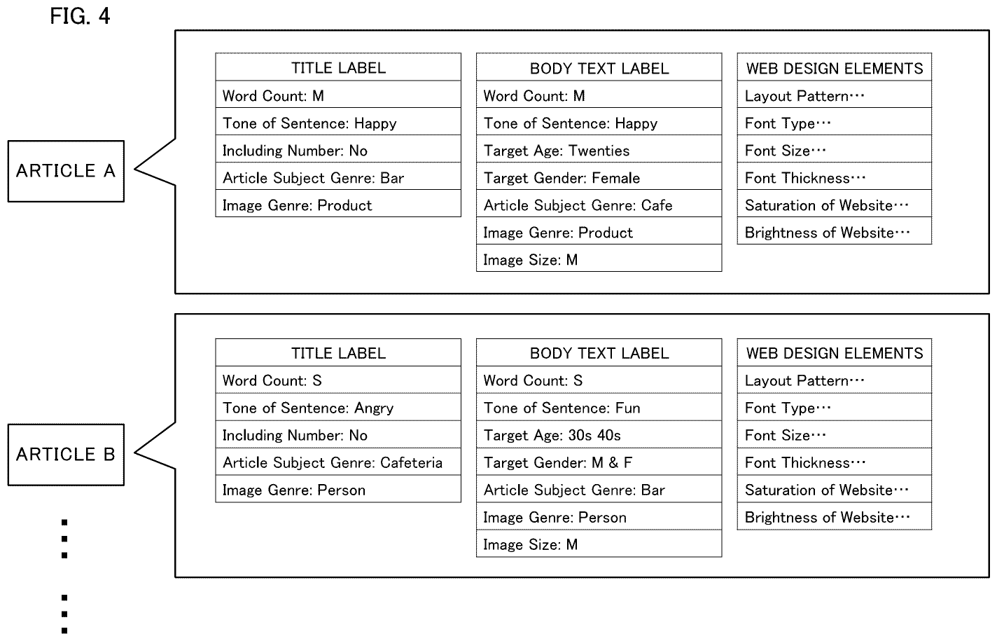

The label assignment unit 201 assigns a label to the article input from the article edit unit 105. The label corresponds to information representing the characteristics of each article. Specifically, the label assignment unit 201 assigns labels regarding “title” and “body text” of the article as illustrated in FIG. 4.

In FIG. 4, in order to represent the characteristics of the title of the article A, the label assignment unit 201 assigns, to the article A, a title label including “Word Count: M”, “Tone of Sentence: Happy”, “Including Number: No”, “Article Subject Genre: Bar”, and “Image Genre: Product”. Moreover, in FIG. 4, in order to represent the characteristics of the body text of the article A, the label assignment unit 201 assigns, to the article A, a body text label including “Word Count: M”, “Tone of Sentence: Happy”, “Target Age: 20s”, “Target Gender: Female”, “Article Subject Genre: Cafe”, “Image Genre: Product”, and “Image Size: M.”

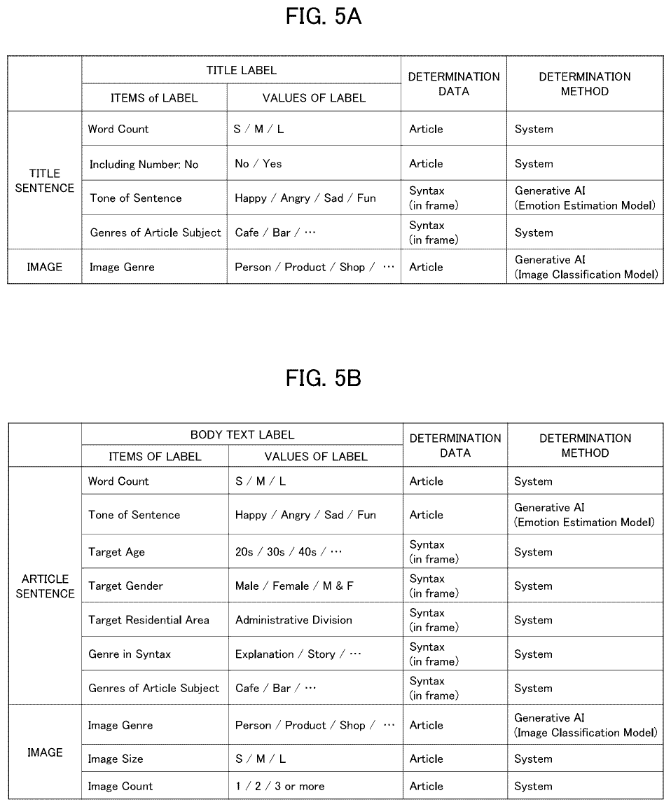

FIG. 5A and FIG. 5B illustrate examples of a label assignment method. FIG. 5A illustrates an example of the label assignment method for assigning the title label, and FIG. 5B illustrates an example of the label assignment method for assigning the text label. From FIG. 5A and FIG. 5B, each of the “title label” and the “text label” includes items of the label and values of the label. The items of the label are determined in advance, and the label assignment unit 201 generates a title label and a body label by determining respective values of the label corresponding to the items of the label.

In FIG. 5A and FIG. 5B, “determination data” are data used to determine label values, and include the article and the syntax. The article is an article published on the website. The syntax is a syntax used to generate the article. The label assignment unit 201 may use a business profile, a questionnaire answer, an instructive sentence, etc. used for generating the article, as determination data in addition to the syntax. The label assignment unit 201 determines respective values of the label for the items of the label in which the determination data indicates the article, based on the title of the article or the body text of the article published on the website. Also, the label assignment unit 201 determines a value of a label for each item of the label in which the determination data indicates the syntax, based on data such as the syntax used to generate the article.

Each “determination method” in FIG. 5A and FIG. 5B is a method for determining the values of the label, and there are a determination method by a system and a determination method by a generative AI. The system indicates that the value of the label is determined from the determination data according to a predetermined criterion. For instance, the label assignment unit 201 may determine whether the word count or the image size is L (large), M (medium), or S (small) based on a predetermined threshold value. Moreover, the label assignment unit 201 may determine presence or absence of a number, each genre, and each target by performing a character search on the determination data based on a predetermined word, etc.

The generative AI is to determine the values of the label in response to an input of the determination data to the generative AI. In FIG. 5A and FIG. 5B, there are an emotion estimation model and an image classification model as the generative AI. The emotion estimation model is, for instance, a natural language process model which classifies, in response to an input of a sentence, the sentence into one of the following emotions: happy, angry, sad, or fun, and BERT (Bidirectional Encoder Representations from Transformers), etc. may be used. Moreover, for instance, the image classification model is an AI model for determining to which genre (e.g., person, product, shop, etc.) an image input is classified in response to an input of the image, and may be formed by such as a CNN (Convolutional Neural Network), etc.

The title label and the text label shown in FIG. 4 are examples, and labels are not limited thereto. The label assignment methods shown in FIG. 5A and FIG. 5B are examples, and the label assignment methods are not limited thereto.

Referring back to FIG. 3, the label assignment unit 201 outputs a label assignment result of each article to the article analysis unit 203.

The log record unit 202 receives the access history from the content publishing system 2. The log record unit 202 obtains the total number of accesses and a total dwell time for each article based on the access history. The log record unit 202 records the total number of accesses (hereinafter, also referred to as a “browsing count”), and the total dwell time (hereinafter, also referred to as a “browsing time”) in the DB 15 in association with information uniquely identifying the article. Information associating the information uniquely identifying the article with the browsing count and the browsing time is also referred to as a “browsing log” hereafter.

The article analysis unit 203 analyzes the title of the article and the body text of the article based on the label assignment result of the article input from the label assignment unit 201 and the browsing logs acquired from the DB 15.

### (1) Analysis of Title

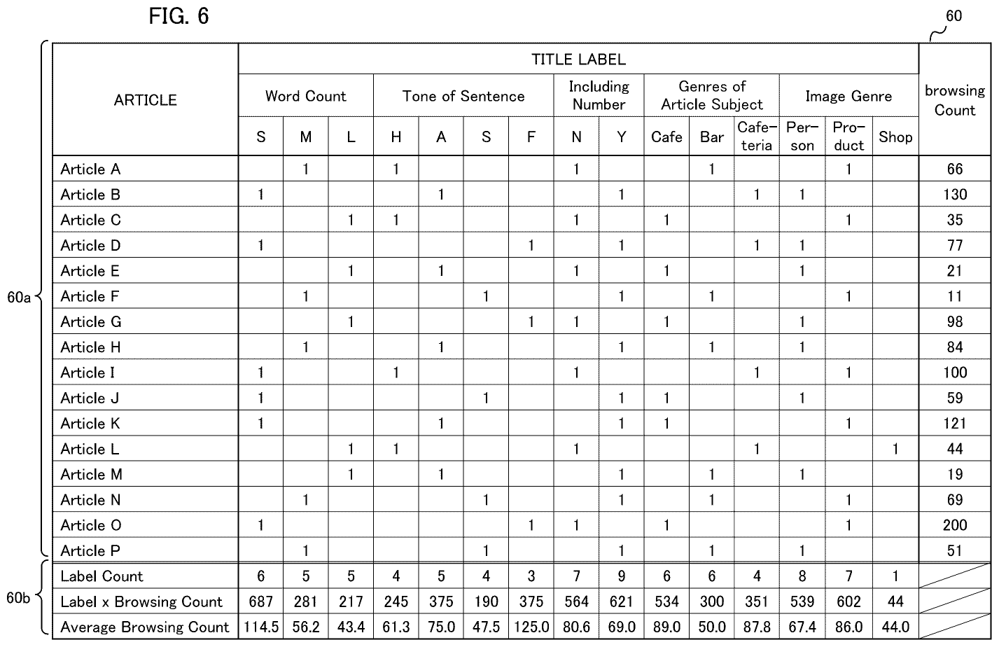

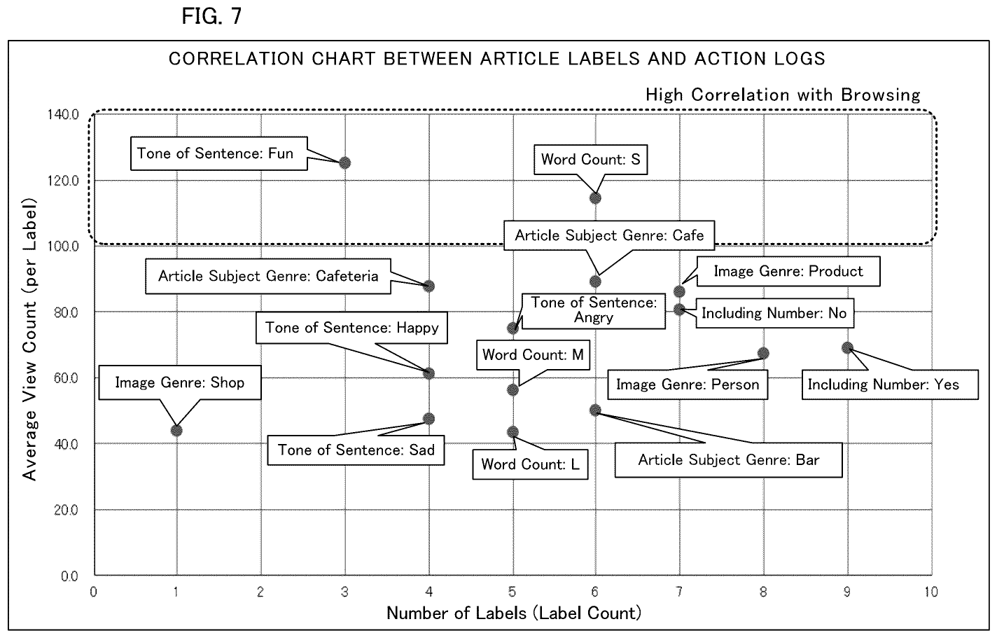

The article analysis unit 203 analyzes the characteristics of the titles tending to be browsed based on the title label of each article and the browsing count of each article. FIG. 6 and FIG. 7 show examples of a correlation analysis performed by the article analysis unit 203. As illustrated in FIG. 6, the article analysis unit 203 analyzes the relationship between each label included in the title label and the browsing count. Then, the article analysis unit 203 represents the analysis result by a scatter plot as illustrated in FIG. 7.

An analysis table 60 in FIG. 6 include an analysis data 60a and an analysis result 60b. The analysis data 60a includes the label assignment result of each article and the browsing count of each article. In FIG. 6, there are articles A to P, and the label assigned to each article is flagged with “1”.

The analysis result 60b includes data of “Label Count,” “Label x Browsing Count,” and “Average Browsing Count.” The “Label Count” indicates the number of articles containing the label of each column. The “Label x Browsing Count” indicates the total browsing count of the article. The “Average Browsing Count” indicates a value obtained by dividing the “Label x Browsing Count” by the “Label Count,” and represents an average of browsing counts with respect to the label of each column. For instance, with respect to the “Word Count: S” in FIG. 6, “6” is input for the “Label Count”, and indicates that there are six articles (articles B, D, I, J, K, and O) having a title of “Word Count: S.” In addition, “687” is input for the “Label x Browsing Count”, and indicates a total browsing count with respect to six articles described above. Moreover, “114.5” is input for the “Average Browsing Count”, and indicates an average of the browsing times with respect to the “Word Count: S”.

Then, the article analysis unit 203 analyzes each label of which the average browsing count is equal to or greater than a predetermined threshold TH1, to be a label having a higher correlation with browsing (e.g., having characteristics of the title tending to be browsed).

Next, the article analysis unit 203 represents the analysis result in FIG. 6 by the scatter plot as shown in FIG. 7. FIG. 7 is the scatter plot in which a vertical axis represents the average browsing count and a horizontal axis represents the label count. In FIG. 7, the predetermined threshold value TH1 indicates 100, and the article analysis unit 203 analyzes “Tone of Sentence: Fun” and “Word Count: S” as labels having the higher correlation with browsing. The article analysis unit 203 outputs the analysis result to the modification unit 204.

### (2) Analysis of Body Text

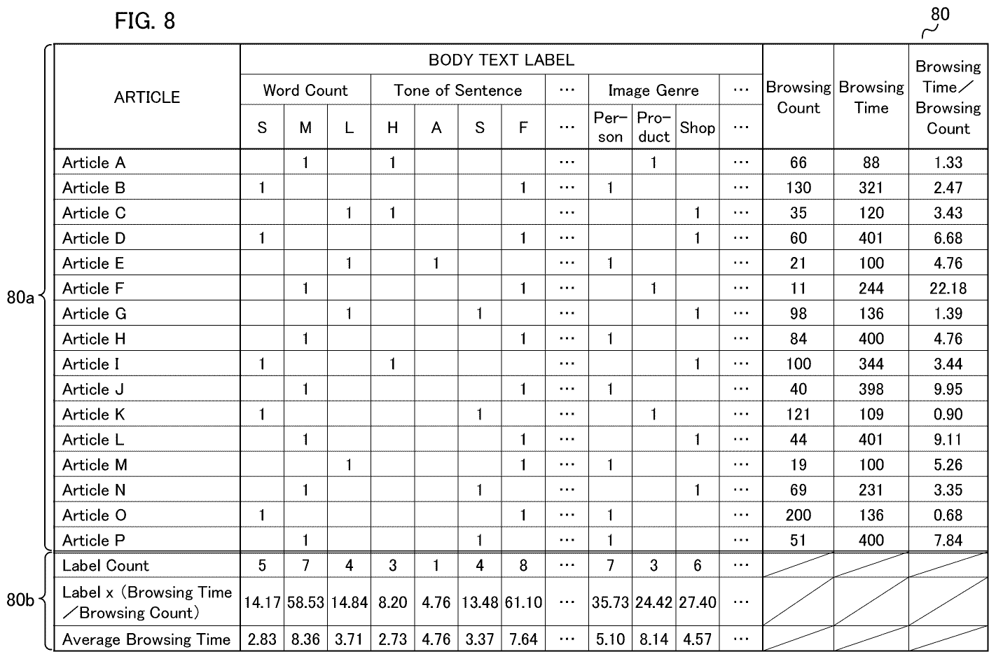

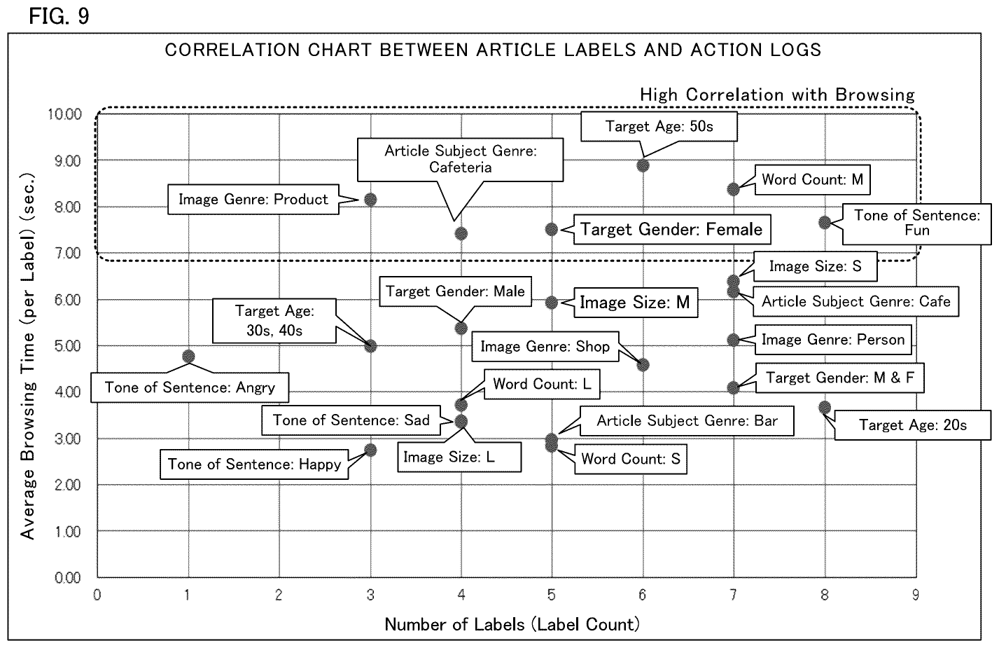

The article analysis unit 203 analyzes the characteristics of the body text tending to be browsed based on the body text label of each article, the browsing count of each article, and the browsing time of each article. FIG. 8 and FIG. 9 show examples of the correlation analysis performed by the article analysis unit 203. As illustrated in FIG. 8, the article analysis unit 203 analyzes a relationship between each label included in the body text label and an average browsing time. Then, the article analysis unit 203 expresses the analysis result by a scatter plot as illustrated in FIG. 9.

An analysis table 80 in FIG. 8 includes analysis data 80a and an analysis result 80b. The analysis data 80a includes the label assignment result of each article, the browsing count of each article, the browsing time of each article, and the average browsing time (browsing time/browsing count) of each article. In FIG. 8, there are the articles A to P, and the label assigned to each article is flagged with “1”.

The analysis result 80b includes data of “Label Count”, “Label x (Browsing Time/Browsing Count)” and “Average Browsing Time”. The “Label Count” indicates the number of articles that contain the label of each column. The “Label x (Browsing time/Browsing Count)” indicates a total of respective average browsing times (Browsing time/Browsing Count) for the articles. The “Browsing Average Time” indicates a value obtained by dividing the “Label x (Browsing Time/Browsing Count)” by the “Label Count”, and represents an average of browsing times for the label of each column. For instance, for “Word Count: S” in FIG. 8, “5” is input and indicates that there are five articles (articles B, D, I, K, and O) with “Word Count: S” for the body text. In addition, for “Label x (Browsing Time/Browsing Count)”, “14.17” is input and indicates a total of average browsing times (browsing time/browsing count) for the five articles described above. Moreover, for “Average Browsing Time”, “2.83” is input and indicates an average of browsing times as represented as “Word Count: S”.

Next, the article analysis unit 203 analyzes each label with which the average browsing time is equal to or more than a predetermined threshold value TH2 as a label having the higher correlation with browsing (e.g., having characteristics of the body text tending to be browsed).

Next, the article analysis unit 203 represents the analysis result in FIG. 8 by the scatter diagram illustrated in FIG. 9. FIG. 9 is the scatter plot where a vertical axis represents the average browsing time (sec.) and a horizontal axis represents the label count. In FIG. 9, the predetermined threshold value TH2 is 7, and the article analysis unit 203 analyzes “Image Genre: Product,” “Article Subject Genre: Cafeteria,” “Target Gender: Female,” “Target Age: 50s,” “Word Count: M,” and “Tone of Sentence: Fun” as labels having the higher correlation with browsing. The article analysis unit 203 outputs the analysis result to the modification unit 204.

The modification unit 204 changes various data for use in generating an article based on the analysis result input from the article analysis unit 203. The various data may include, for instance, the syntax, the instructive sentence, the questionnaire, and the edit screen.

For instance, the modification unit 204 may change the syntax based on the characteristics of the title tending to be browsed. In a case where the title label having the higher correlation with browsing is “Tone of Sentence: Fun” or “Word Count: S”, the modification unit 204 adds an instruction such as “Create a fun toned title!” or

“Keep the title to a maximum of xx words” to the syntax.

Moreover, the modification unit 204 may change the syntax based on the characteristics of the body text tending to be browsed. In a case where the body text label having the higher correlation with browsing is “Tone of Sentence: Fun” and “Word Count: M”, the modification unit 204 adds an instruction such as “Create a fun toned sentence” or “Keep the word count of the sentence to at least xx words and no more than yy words” to the syntax.

Also, the modification unit 204 may change the questionnaire based on the characteristics of the body text tending to be browsed. For instance, the modification unit 204 may add items to the questionnaire in order to specify the target age of the article, the target gender of the article, the tone of sentence, etc. In this case, the modification unit 204 adds a message to the questionnaire based on the characteristics of the body text tending to be browsed. For instance, in a case where the text label having the higher correlation with browsing is “Tone of Sentence: Fun,” “Target Gender: Female,” and “Target Age; 50s”, the modification unit 204 adds a message such as “A fun tone of the sentence tends to be preferred.” or “Articles for female readers in their 50s tend to be browsed”.

Moreover, the modification unit 204 may add a message to the edit screen based on the title or the characteristics of the body text tending to be browsed. For instance, in a case where there is an “Image Genre: Product” in the title label and the text label having the higher correlation with browsing, the modification unit 204 may add a message such as “Including an image of the product in the title makes it easier to be browsed” or “Including an image of the product in the body text makes it easier to be browsed” to the edit screen.

In the configuration described above, the syntax determination unit 102, the instructive sentence generation unit 103, the article generation unit 104, the article edit unit 105, and the log record unit 202 correspond to an example of an acquisition means, the label assignment unit 201 and the article analysis unit 203 correspond to an example of a specifying means, and the modification unit 204 corresponds to an example of a creation means.

### [Process Flow]

Next, the generation process of the article by the generation unit 100 and the analysis process of the browsing logs by the analysis unit 200 will be described.

### (Generation Process of Article)

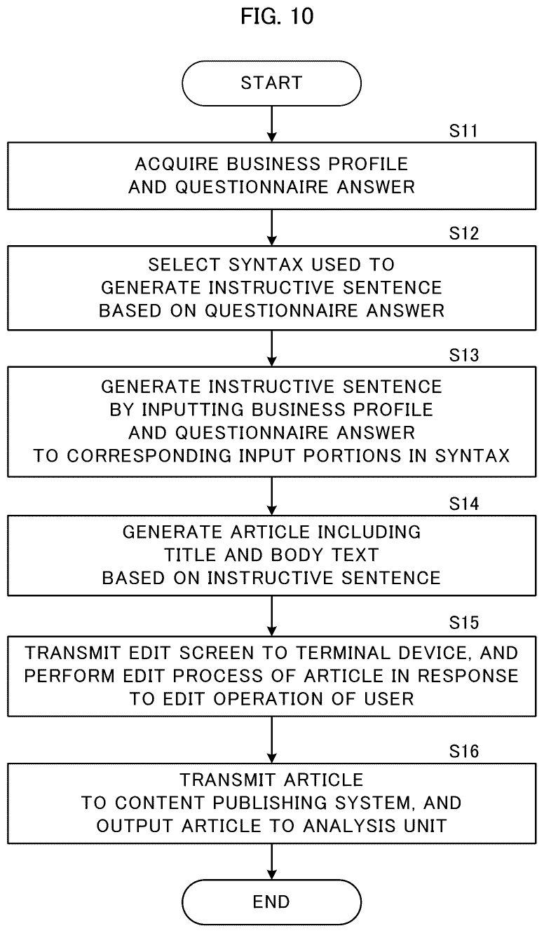

FIG. 10 is a flowchart of the generation process of the article by the generation unit 100. This generation process is realized by the processor 12 shown in FIG. 2 executing a program prepared in advance and operating as each element shown in FIG. 3.

First, the generation unit 100 receives the business profile and the questionnaire answer from the terminal device 5. The business profile and the questionnaire answer are input to the information acquisition unit 101 (step S11). The information acquisition unit 101 outputs the business profile and the questionnaire answer to the syntax determination unit 102 and the instructive sentence generation unit 103.

Next, the syntax determination unit 102 selects the syntax used to generate an instructive sentence from the plurality of syntaxes stored in the DB 15 (step S12). For instance, the syntax determination unit 102 refers to the syntax table and selects the syntax corresponding to the answer of a certain item among the questionnaire responses input from the information acquisition unit 101 as the syntax for generating the instructive sentence. The syntax determination unit 102 outputs the selected syntax to the instructive sentence generation unit 103.

Next, the instructive sentence generation unit 103 generates the instructive sentence by inputting the business profile and the questionnaire answer to the corresponding input portion in the syntax (step S13) The instructive sentence generation unit 103 outputs the generated instructive sentence to the article generation unit 104.

Next, the article generation unit 104 generates an article including a title and a body text based on the instructive sentence (step S14). Specifically, the article generation unit 104 inputs the instructive sentence to the generative AI, and acquires an article as a reply to the instructive sentence from the generative AI. The article generation unit 104 outputs the article generated by the generative AI to the article edit unit 105.

Next, the article edit unit 105 generates an edit screen for editing the article input from the article generation unit 104, and transmits the generated edited screen to the terminal device 5. Moreover, the article edit unit 105 performs the article edit process according to edit operations of the user (step S15).

Next, in response to receiving the publication operation from the terminal device 5, the article edit unit 105 transmits a relevant article to the content publishing system 2 and outputs the relevant article to the analysis unit 200 (step S16). After that, the generation process is terminated.

### (Analysis Process of Browsing Logs)

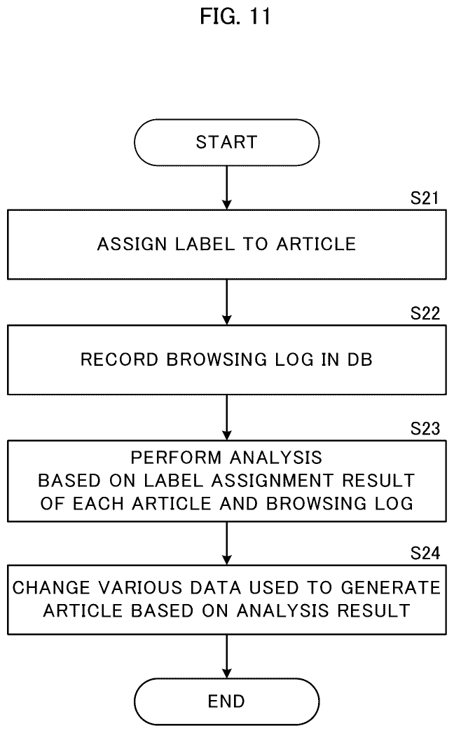

FIG. 11 is a flowchart of the analysis process of the browsing logs by the analysis unit 200. This analysis process is realized by the processor 12 shown in FIG. 2 executing a corresponding program prepared in advance and operating as each element shown in FIG. 3.

First, the label assignment unit 201 assigns a label to the article input from the article edit unit 105 (step S21). Specifically, the label assignment unit 201 assigns labels concerning “title” and “body text” of the article as illustrated in FIG. 4. The label assignment unit 201 outputs the assignment result of the label for each article to the article analysis unit 203.

Next, the log record unit 202 receives the access history from the content publishing system 2. The log record unit 202 obtains the browsing count and the browsing time for each article based on the access history. Then, the log record unit 202 records the browsing logs in the DB 15 in which the browsing count and the browsing time are associated with the information uniquely identifying the article (step S22).

Next, the article analysis unit 203 performs the analysis based on the assignment result of the label of each article input from the label assignment unit 201 and the browsing logs acquired from the DB 15 (step S23). Specifically, the article analysis unit 203 analyzes the characteristics of the title tending to be browsed based on the title label of each article and the browsing count of each article. The article analysis unit 203 analyzes the characteristics of the text tending to be browsed based on the text label of each article and the number and the viewing time of each article. The article analysis unit 203 outputs the analysis result to the modification unit 204. Next, the modification unit 204 changes various data for use in generating the article based on the analysis result input from the article analysis unit 203 (step S24). After that, the analysis process is terminated.

### [Modification]

Next, a modification of the first example embodiment will be described.

The content publishing system 2 is not limited to the website; for instance, the content may be disclosed to a predetermined SNS (Social Network Service). In this case, instead of the access history, the content publishing system 2 records the number of accesses with respect to the content or a reaction to the content (for instance, the number of “likes,” the number of comments, the number of saves, the number of followers, etc.). The analysis unit 200 analyzes the characteristics of the content tending to be browsed by using the number of accesses to the content or the reaction to the content.

According to the first example embodiment and the modification whereof, it is possible to provide the information processing device capable of generating an appropriate content based on the analysis result of one or more browsing logs.

### Second Example Embodiment

Next, a second example embodiment will be described. An information processing device 10a of the second example embodiment can create an image and a hashtag in accordance with a content of an article. The information processing device 10a of the second example embodiment can perform analysis of a hashtag in addition to an analysis of a body text of the article and the image inserted in the article. Accordingly, it is possible for a user to understand the image and the hashtag which are likely to be browsed. Note that an overall configuration and a hardware configuration is the same as those of the first example embodiment, and thus, explanations thereof will be omitted.

### [Functional Configuration]

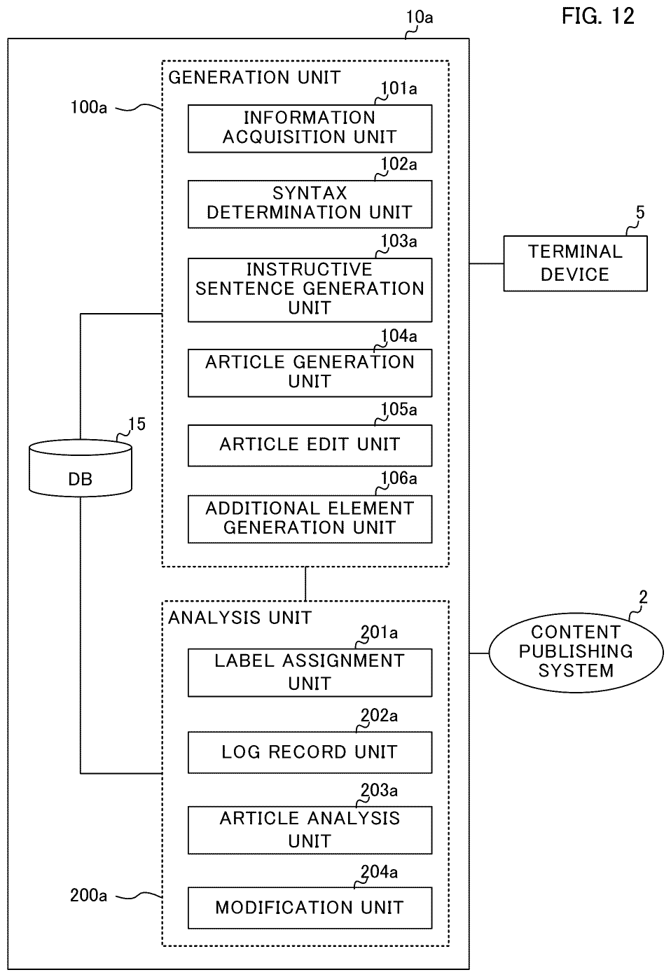

FIG. 12 is a block diagram illustrating a functional configuration of an information processing device 10a according to the second example embodiment. The information processing device 10a functionally includes a generation unit 100a and an analysis unit 200a.

### (Generation Unit)

First, the generation unit 100a will be described. The generation unit 100a is based on the generation unit 100 of the information processing device 10 according to the first example embodiment, and further includes an additional element creation unit 106a. Note that an information acquisition unit 101a, a syntax determination unit 102a, an instructive sentence generation unit 103a, and an article generation unit 104a are similarly formed and similarly operate as the information acquisition unit 101, the syntax determination unit 102, the instructive sentence generation unit 103, and the article generation unit 104 of the generation unit 100, and thus, explanations thereof will be omitted.

The additional element creation unit 106a generates an image and a hashtag related to the articles using the generative AI.

Specifically, in a case where the user desires to incorporate an image or a hashtag into an article, the user operates the terminal device 5 and transmits a request for creating an image or a hashtag to the information processing device 10a. For instance, the user transmits a creation request including a genre of a creation (i.e., whether to create the image or the hashtag) and a platform for publishing article (hereinafter also referred to as a “publication target”), to the information processing device 10a. The creation request is input into the additional element creation unit 106a.

The additional element creation unit 106a selects a question sentence and a syntax from the DB 15. The question sentence is a question for questioning the user, and includes question items concerning the image and the hashtag. The syntax selected by the additional element creation unit 106a is a syntax used for generating the image and the hashtag. Specifically, the syntax is a template for the instructive sentence for instructing to generate the image and the hashtag.

For instance, a table, in which the question sentence and the syntax are associated with the publication target, is stored for each category of the creation in the DB 15. Based on the creation request of the user, the additional element creation unit 106a refers to the table corresponding to the genre of the creation, and selects the question sentence and the syntax which correspond to the publication target.

The additional element creation unit 106a transmits the question sentence to the terminal device 5. The question sentence may include, for instance, one or more question items, such as the content of the article to be published, the number of images or hashtags to be generated, a style of the image or hashtag to be generated, etc. The user inputs an answer to each question through the terminal device 5 and transmits each answer to the information processing device 10a.

The syntax includes one or more input portions. The additional element creation unit 106a generates an instructive sentence by inputting each answer of the user to a corresponding input portion of the syntax. The additional element creation unit 106a inputs an instructive sentence in the generative AI and acquires an image or hashtag as an answer from the generative AI. The additional element creation unit 106a transmits the image or hashtag to the terminal device 5. The user can insert the image and hashtag generated by the additional element creation unit 106a into the article, by performing the edit operation described later.

Note that instead of the image, the additional element creation unit 106a may acquire an explanation sentence of the image from the generative AI, and may transmit to the terminal device 5. It is possible for the user to prepare an image related to the article by taking a picture etc. in accordance with the explanation sentence of the image.

The article edit unit 105a generates an edit screen for editing the article and transmits the generated edit screen to the terminal device 5. Then, the article edit unit 105a receives each edit operation with respect to the article from the terminal device 5. For instance, the user may perform the edit operations such as modifying text, inserting an image, changing a font, etc. for the article displayed on the display of the terminal device 5. The article edit unit 105a performs the article edit process in response to the edit operation of the user. Then, in a case of receiving the publication operation from the terminal device 5, the article edit unit 105a transmits a relevant article to the content publishing system 2, and outputs the relevant article to the analysis unit 200a.

### (Analysis Unit)

Next, the analysis unit 200a will be described. Since the analysis unit 200a has a similar structure as the analysis unit 200 of the information processing device 10 according to the first example embodiment, a label assignment unit 201a and a log record unit 202a are similar to the label assignment unit 201 and the log record unit 202; however, process details of an article analysis unit 203a and a modification unit 204a are different from the article analysis unit 203a and the modification unit 204a of the analysis unit 200.

Note that in the second example embodiment, a hashtag may be inserted in the body text of the article. In such case, the label assignment unit 201a does not assign any labels related to the hashtag to the articles, and the article analysis unit 203a uses the hashtag as is for the analysis.

The article analysis unit 203a analyzes the title of the article and the body text of the article based on the label assignment result of the article input from the label assignment unit 201a, the hashtag included in the articles, and the browsing logs acquired from the DB 15.

### (1) Analysis of Title

Since the analysis of the title is the same as the analysis of the title by the article analysis unit 203 of the information processing device 10 according to the first example embodiment, explanations thereof will be omitted.

### (2) Analysis of Body Text

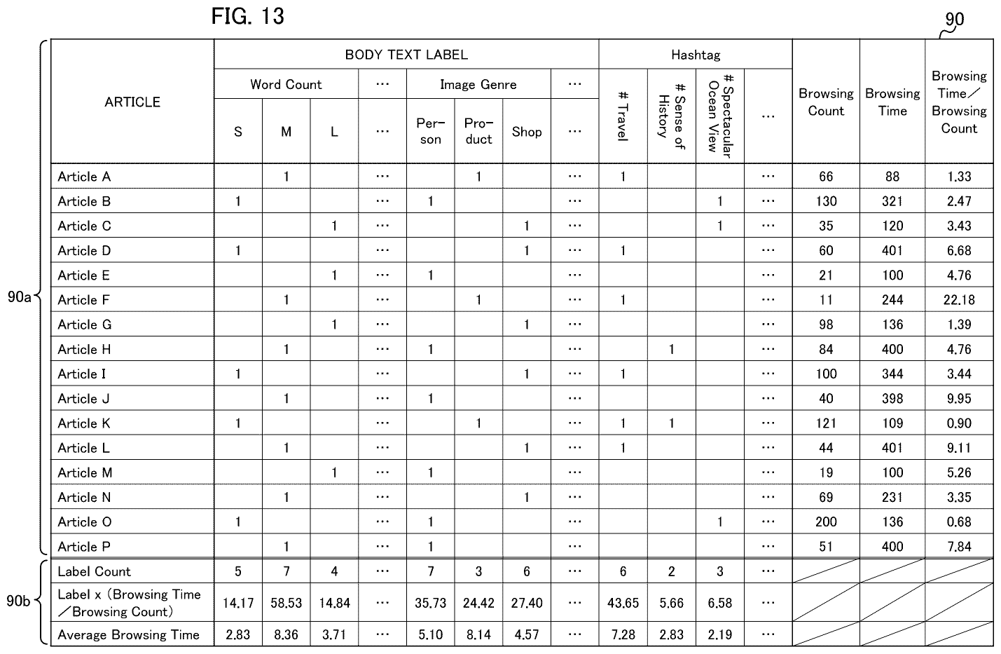

The article analysis unit 203a analyzes the characteristics of the body text tending to be browsed based on the body text label of each article, the hashtag of each article, the browsing count of each article, and the browsing time of each article. FIG. 13 shows an example of a correlation analysis by the article analysis unit 203a. The analysis table 90 in FIG. 13 include analysis data 90a and an analysis result 90b. The analysis data 90a includes the label assignment result of each article, the hashtag of each article, the browsing count of each article, the browsing time of each article, and the average browsing time (browsing time/browsing count) of each article. In FIG. 13, there are articles A to P, and the label assigned to each article is flagged with “1”, and the hashtag assigned to each article is flagged with “1”.

The analysis result 90b includes the “label count”, the “label x (browsing time/browsing count)” and the “average browsing time”. The “label count” indicates the number of articles containing the label of the column or the number of articles containing the hashtag of the column. The “label x (browsing time/browsing count)” indicates the total of the average browsing time (browsing time/browsing count) for the articles. The “average browsing time” is a value obtained by dividing the “Label x (browsing time/browsing count)” by the “label count”, and represents the average browsing time for the label or the hashtag of that column.

For instance, for the hashtag “#Travel” in FIG. 13, “6” is input and indicates that there are six articles (articles A, D, F, I, K, and L) to which the hashtag “#Travel” is attached. In addition, “43.65” is input and indicates the total of the average browsing times (browsing time/browsing count) for the six articles described above. Moreover, for the “browsing average time”, “7.28” is input and indicates the average of the browsing times of “#Travel”.

Then, the article analysis unit 203a analyzes each label which the average browsing time is equal to or more than a predetermined threshold value TH3 as the label having a higher correlation with browsing (i.e., characteristics of the body text tending to be browsed).

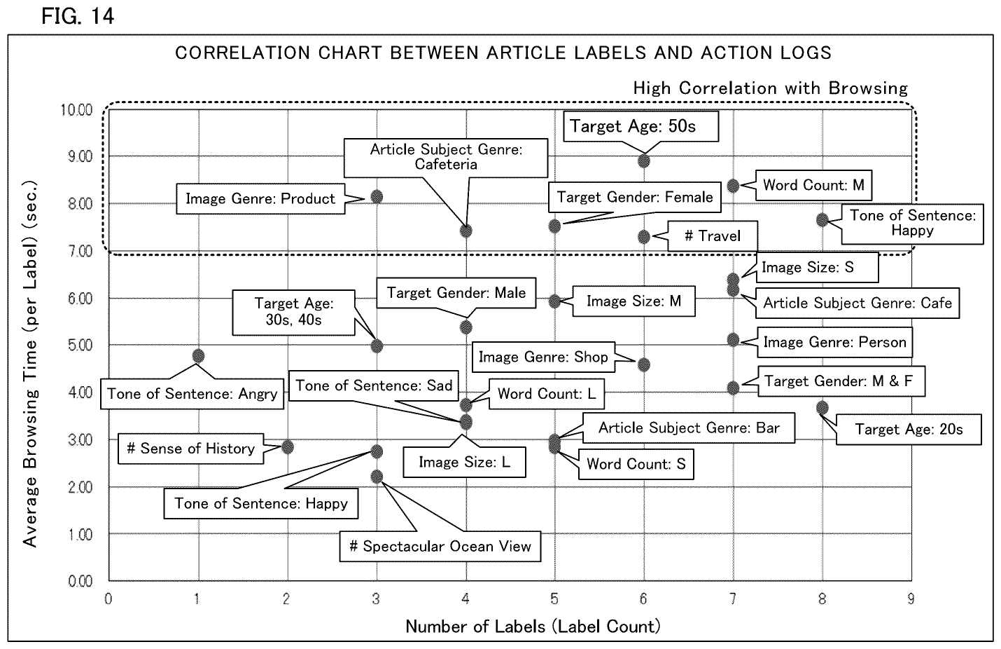

Next, the article analysis unit 203a represents the analysis result illustrated in FIG. 13 with a scatter plot illustrated in FIG. 14. FIG. 14 is the scatter plot where a vertical axis represents the average browsing time (sec.) and a horizontal axis represents the label count. In FIG. 14, the predetermined threshold TH3 is 7, and the article analysis unit 203a analyzes “Image Genre: product,” “Article Subject Genre: Cafeteria,” “Target Gender: Female,” “Target Age: 50s,” “Word Count: M,” “Tone of Sentence: Fun,” and “#Travel” as labels having the higher correlation with browsing. The article analysis unit 203a outputs an analysis result to the modification unit 204a.

The modification unit 204a changes various data for use in generating an article based on the analysis result input from the article analysis unit 203a. The various data may include, for instance, the syntax, the instructive sentence, the questionnaire, the question sentence, and the edit screen.

For instance, the modification unit 204a may change the questionnaire, the question, or the edit screen based on the characters of the body text tending to be browsed. In a case where the hashtag having the higher correlation with browsing is “#Travel”, the modification unit 204a may add a message such as “the article concerning travel tending to be browsed” to the questionnaire or questionnaire sentence. In addition, the modification unit 204a may add a message such as “the article related to #Travel tends to be browsed” to the edit screen. According to the second example embodiment, it is possible to provide the information processing device capable of generating an appropriate content based on the analysis result of one or more browsing logs.

### Third Example Embodiment

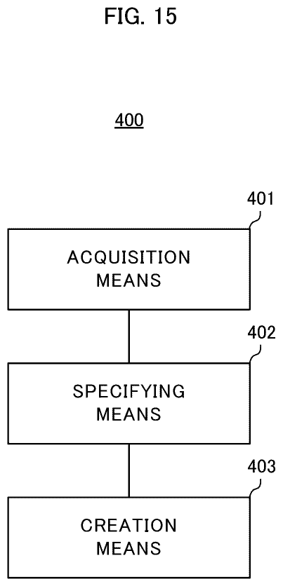

FIG. 15 is a block diagram illustrating a functional configuration of an information processing device according to a third example embodiment. An information processing device 400 includes an acquisition means 401, a specifying means 402, and a creation means 403.

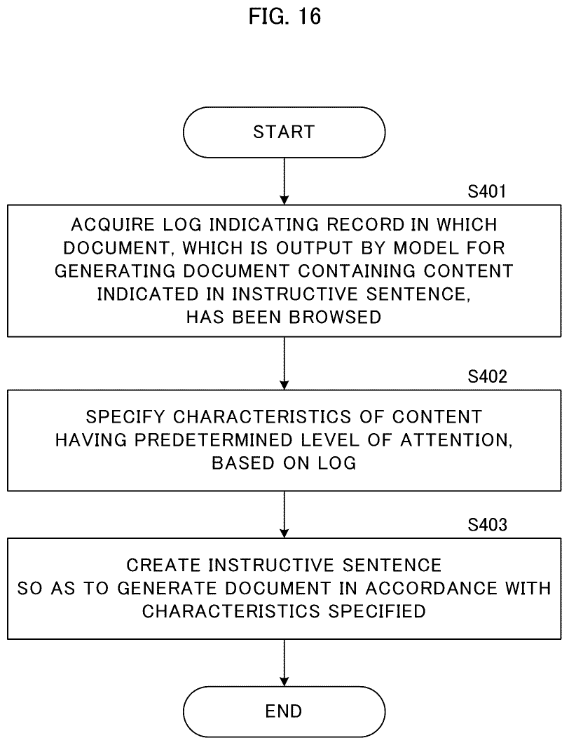

FIG. 16 is a flowchart illustrating process performed by the information processing device according to the third example embodiment. The acquisition means 401 acquires each log indicating a record in which a document, which is output by the model for generating the document including a content indicated in an instructive sentence, has been browsed (step S401). The specifying means 402 specifies the characteristics of the content having a predetermined level of attention based on one or more logs (step S402). The creation means 403 creates an instructive sentence to generate the document according to the specified characteristics (step S403).

According to the information processing device 400 of the third example embodiment, it is possible to generate an appropriate content based on the analysis result of one or more browsing logs.

A part or all of the example embodiments described above may also be described as the following supplementary notes, but not limited thereto.

(Supplementary note 1)

An information processing device comprising:
an acquisition means configured to acquire a log indicating a record in which a document, which is output by a model for generating the document containing a content indicated in an instructive sentence, has been browsed;
a specifying means configured to specify characteristics of the content having a predetermined level of attention based on the log; and
a creation means configured to create the instructive sentence so as to generate the document in accordance with the characteristics specified.
   (Supplementary note 2)

The information processing device according to supplementary note 1, further comprising a template storage means configured to store a template of the instructive sentence, wherein
the creation means creates the template so as to generate the document in accordance with the characteristics specified.
   (Supplementary note 3)

The information processing device according to supplementary note 1, further comprising a questionnaire sending and receiving means configured to send a questionnaire to a user terminal, and receive a questionnaire answer from the user terminal, wherein
the instructive sentence includes the questionnaire answer, and
the creation means creates the questionnaire so as to generate the document in accordance with the characteristics specified.
   (Supplementary note 4)

The information processing device according to supplementary note 1, wherein
the log includes a browsing count and a browsing time for each document, and
the level of attention is determined based on the browsing count of the document and the browsing time of the document.
   (Supplementary note 5)

The information processing device according to supplementary note 1, wherein
the log indicates a reaction of a viewer with respect to the document, and
the level of attention is determined based on the reaction.
   (Supplementary note 6)

The information processing device according to supplementary note 1, wherein the specifying means analyzes, by a correlation analysis, a relationship between the level of attention with respect to the document and the characteristics of the content included in the document, and specifies the characteristics of the content including the predetermined level of attention based on an analysis result.

(Supplementary note 7)

The information processing device according to supplementary note 1, wherein the characteristics of the content include one or more of a genre of the document, a word count of the document, an emotion of the document, presence or absence of a number, a layout of the document, a target age of the document, an image and color thereof included in the document, and hashtag assigned to the document.

(Supplementary note 8)

An information processing method performed by a computer, the information processing method comprising:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.
   (Supplementary note 9)

A non-transitory computer-readable recording medium storing a program causing a computer to execute processing of:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.
   (Supplementary note 10)

An information processing device comprising:
a relationship specifying means configured to specify a relationship between a level of attention to a document and features representing characteristics of a content;
a feature specifying means configured to specify features having a predetermined level of attention based on the relationship; and
a content creation means configured to create a content having the characteristics represented by the features specified.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Applications 2024-032990, filed on Mar. 5, 2024 and 2024-110680, filed on Jul. 10, 2024 the disclosure of which is incorporated herein in its entirety by reference.

### DESCRIPTION OF SYMBOLS

1 Content Analysis System
2 Content Publishing System
5,20 Terminal Device
10 Information Processing Device
15 Database (DB)
100, 100a Generation Unit
101, 101a Information Acquisition Unit
102, 102a Syntax Determination Unit
103, 103a Instructive Sentence Generation Unit
104, 104a Article Generation Unit
105, 105a Article Edit Unit
106a Additional Element Creation Unit
200, 200a Analysis Unit
201, 201a Label Assignment Unit
202, 202a Log Record Unit
203, 203a Article Analysis Unit
204, 204a Modifiation Unit

1. An information processing device comprising:
at least one memory configured to store instructions; and
at least one processor configured to execute the instructions to:
acquire a log indicating a record in which a document, which is output by a model for generating the document containing a content indicated in an instructive sentence, has been browsed;
specify characteristics of the content having a predetermined level of attention based on the log; and
create the instructive sentence so as to generate the document in accordance with the characteristics specified.

2. The information processing device according to claim 1, wherein the processor
stores a template of the instructive sentence, and
creates the template so as to generate the document in accordance with the characteristics specified.

3. The information processing device according to claim 1, wherein
the processor sends a questionnaire to a user terminal, and receives a questionnaire answer from the user terminal,
the instructive sentence includes the questionnaire answer, and
the processor creates the questionnaire so as to generate the document in accordance with the characteristics specified.

4. The information processing device according to claim 1, wherein
the log includes a browsing count and a browsing time for each document, and
the level of attention is determined based on the browsing count of the document and the browsing time of the document.

5. The information processing device according to claim 1, wherein
the log indicates a reaction of a viewer with respect to the document, and
the level of attention is determined based on the reaction.

6. The information processing device according to claim 1, wherein the processor analyzes, by a correlation analysis, a relationship between the level of attention with respect to the document and the characteristics of the content included in the document, and specifies the characteristics of the content including the predetermined level of attention based on an analysis result.

7. The information processing device according to claim 1, wherein the characteristics of the content include one or more of a genre of the document, a word count of the document, an emotion of the document, presence or absence of a number, a layout of the document, a target age of the document, an image and color thereof included in the document, and hashtag assigned to the document.

8. An information processing method performed by a computer, the information processing method comprising:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.

9. A non-transitory computer-readable recording medium storing a program causing a computer to execute processing of:
acquiring a log indicating a record in which a document, which is output by a model for generating the document containing a content indicated in an instructive sentence, has been browsed;
specifying characteristics of the content having a predetermined level of attention based on the log; and
creating the instructive sentence so as to generate the document in accordance with the characteristics specified.
